(19) United States
(12) Patent Application Publication
(10) Pub. No.: US 2015/0199534 A1
(43) Pub. Date: Jul. 16, 2015

(54) Secure Storage System and Uses Thereof

(71) Applicant: MD Databank Corp, Leduc County (CA)

(72) Inventors: Gordon Eric Francis, Leduc County (CA); Herbert William Lainchbury, North Saanich (CA)

(21) Appl. No.: 14/414,423

(22) PCT Filed: Jul. 10, 2013
(86) PCT No.: PCT/IB2013/002046

§ 371 Date: Jan. 12, 2015

Related U.S. Application Data
(60) Provisional application No. 61/670,871, filed on Jul. 12, 2012.

(51) Int. Cl. G06F 21/62; G06F 21/31

(52) U.S. Cl. CPC G06F 21/6218; G06F 21/31

(57) ABSTRACT

The invention described herein provides a data storage system useful for secure access, sharing, storage and archival of electronic documents, such as private, sensitive, proprietary, privileged, and/or otherwise confidential documents, including legal, medical, financial, personal documents. The invention also provides methods of using such data storage system for secure access, sharing, storage and archival of such electronic documents.

### RELATED APPLICATION

This application claims the benefit of priority to U.S. Provisional Application No. 61/670,871, filed on Jul. 12, 2012, the entire content of which is incorporated herein by reference.

### FIELD OF THE INVENTION

The invention relates to a data storage system useful for secure access, sharing, storage and archival of electronic documents, and methods of using such data storage system for secure access, sharing, storage and archival of electronic documents.

### BACKGROUND OF THE INVENTION

Present day electronic devices (such as personal computers, mobile phones, tablets, and other electronic devices) are not equipped for sharing, storing or archiving sensitive electronic documents, where access from third parties, either malicious or inadvertent, poses a significant risk. When it is desirable to make documents accessible from multiple devices, or to share information among a group of people one of two mechanisms are typically employed, (i) additional copies of the documents in question are created and proliferated, and the copies are then transmitted using a variety of technologies/devices, including email, USB thumb drives, external hard drives, memory sticks, or blue tooth file transfer, etc., such that these copies move between machines and among people, or (ii) access to a ‘master’ document is extended through to multiple devices, or to multiple people via a network environment (like a corporate network or a ‘cloud-based’ service).

These approaches for accessing documents from multiple devices for sharing information may be suitable for some forms of electronic documents; however, for highly sensitive information neither solution are adequate or sufficient; instead, both introduce significant risk.

Firstly, the practice of making additional copies of documents for the purposes of sharing them and then disseminating those documents around on various devices and among many people multiplies the risk that a given document will be accessed by an unauthorized party. As additional copies of a document are created and moved about multiple devices, the likelihood of a breach, whether malicious or inadvertent grows significantly. Additionally the proliferation of files to facilitate multi-device access or multi-person access introduces new risks beyond those relating to security and privacy; in particular, if multiple copies of a file exist, it may become challenging to identify or maintain the “master” file.

Secondly, none of these technologies are considered secure. While there are more secure technologies available (e.g., through the use of browser client side certificates and/or smart cards with smart card readers), users typically do not use them because they are cumbersome and require higher levels of technical expertise than most people are willing to acquire and employ. The preferred approach to multi-device and multi-person access to common files has been through common networks or ‘cloud-based’ solutions where the master file exists in only one environment, but may be accessed from multiple devices or by multiple people. To date, excepting with the device described in this claim, network and ‘cloud’ solutions to not employ a security solution that is adequate or sufficient to accommodate the storage of highly sensitive information, like health information, financial information, personal information and other kinds and the like.

Thirdly, a critical concern when sharing highly sensitive information is making sure that the person being shared with is in fact the intended party. Current practice in the network approach to multi-device, multi-person access typically relies solely on username and password (single factor authentication), mostly because of the convenience and familiarity with this solution amongst large user groups. It is a well documented reality today that single factor authentication is easily and often subverted by sharing of credentials and is no longer an appropriate ‘norm’ by which to access, archive or share sensitive information.

Nonetheless, without a convenient way to share highly sensitive information, most individuals who must access electronic information either choose the less secure methods, thus putting themselves and others at risk and potential harm, or they choose not to share the information at all, which has its own risks and may also result in harm to themselves or others.

Finally, and perhaps most menacingly, any online system, no matter how secure, is subject to the constant threat of unauthorized break-in from malicious attackers. Any solution that proposes to provide a multi-device, multi-person solution for sensitive electronic information above must also take into account purposeful attacks intended to compromise the solution, and be devised in such a way so to minimize the possibility of such attacks succeeding.

Thus, improved methods and systems for securely accessing, sharing, storing and archiving electronic documents, especially those containing personal and/or highly sensitive information while at the same time providing convenience are lacking. Proliferation solutions introduce new significant risks relating to data integrity (e.g., identifying or maintaining the master copy) and data security. The network/cloud solutions to multi-device, multi-user file access do not accommodate the extraordinary security requirements for storage of highly sensitive information, and additionally rely on standard and risk-laden single factor authentication.

### SUMMARY OF THE INVENTION

One aspect of the invention provides a data storage system, comprising: (a) a data storage device, comprising an unarchived document module that stores unarchived documents and an archived document module that stores archived documents; (b) a web console server, wherein the web console server receives instruction and/or information from an administrative user (who may have authorities and perhaps legal or professional obligations relating to the custodianship of the data) through a web console user interface, wherein the web console server grant the administrative user access to the web console server after receiving two or more pre-determined security credentials, and wherein the administrative user, having gained access to said web console server, is capable of: (i) obtaining a security code required by a document viewer device to access documents in the unarchived document module; (ii) creating a top-level folder in the unarchived document module (that stores documents in the unarchived document module); (iii) moving a top-level folder between the unarchived document module and the archived document module; (iv) inviting another to become an associate user; (v) granting access to a top-level shared folder to the associate user; (vi) revoking access to a top-level folder previously shared with an associate user; and/or, (vii) preventing the administrative user's account from being used to gain access to the document server (locking down), or reversing locking down; (c) a document server, wherein the document server establishes a secure connection with the document viewer device after receiving the security code provided by a document viewer through the document viewer device, and grants the document viewer access to documents stored in the unarchived document module, wherein the document viewer, having gained access to the unarchived document module, is capable of: (1) creating a sub-folder within the top-level folder in the unarchived document module, or within another sub-folder; and, (2) manipulating [managing (adding, moving, copying, or deleting), viewing, and/or editing] documents stored in the unarchived document module commensurate with a policy/privileged associated with the document viewer.

In certain embodiments, one of the two or more security credentials is a user-determined password.

In certain embodiments, one of the two or more security credentials is a token generated by a physical device (such as a YubiKey).

In certain embodiments, the security code expires at a pre-determined time or after a pre-determined period of time (e.g., every hour, every day, every week, every month, etc.), or expires once per login, or expires after each locking down.

In certain embodiments, the security code is refreshed through the web console interface.

In certain embodiments, the top-level folder contains identification information (such as folder name or the number of documents within the folder).

In certain embodiments, the top-level folder can be designated to be a top-level shared folder (for access by the associate user).

In certain embodiments, the document viewer device is the same device that hosts the web console user interface.

In certain embodiments, the unarchived document module and the archived document module are within the same physical device.

In certain embodiments, the document server and the unarchived document module are within the same physical device.

In certain embodiments, the document viewer device is different from the device that hosts the web console user interface.

In certain embodiments, the unarchived document module and the archived document module are physically distinct devices that may optionally be located in different geographic locations.

In certain embodiments, the document server and the unarchived document module are physically distinct devices.

In certain embodiments, the document viewer device is a personal computer (PC or Macintosh), a tablet device (iPad, PC tablets), or a smart phone (iPhone, android device, blackberry etc.).

In certain embodiments, the secure connection between the document viewer device and the document server is based on SFTP.

In certain embodiments, the content of the archived or unarchived documents is not accessible through the web console user interface or the web console server.

In certain embodiments, content of the archived document module is not visible and not accessible through the document viewer device.

In certain embodiments, the document viewer is the administrative user, or the associate user.

In certain embodiments, the associate user has limited privilege to manage content of the data storage device.

In certain embodiments, communication between the data storage device and the web console server is established by the web console server providing (one-way) instructions that are capable of being processed by the data storage device when the data storage device is ready to process instructions.

In certain embodiments, the data storage system comprises multiple web console servers, each in communication with one administrative user.

In certain embodiments, the document server establishes secure connection with multiple document viewer devices, optionally simultaneously.

In certain embodiments, documents stored in the data storage device are medical records of a patient, wherein the administrative user is a physician of the patient, and the associate user is another physician of the patient.

In certain embodiments, documents stored in the data storage device are proprietary or confidential, and wherein the administrative user is a custodian of the documents.

Another aspect of the invention provides a method of storing documents, comprising saving said documents in a data storage system of any of the above claims.

In certain embodiments, a first portion of said documents are stored in the unarchived document module, and a second portion of said documents are stored in the archived document module.

In certain embodiments, the method further comprises using the web console user interface to gain access said web console server.

In certain embodiments, the method further comprises performing one or more of (i)-(vii).

In certain embodiments, the method further comprises using a document viewer device to access the unarchived document module.

In certain embodiments, the method further comprises performing (1) or (2).

In certain embodiments, the documents are confidential legal documents/instruments (e.g., certificate, deed, bond, contract, agreement, will, invention disclosure etc.).

In certain embodiments, the documents are medical documents (patient lab test data, health history, family health history, treatment history, diagnosis, prognosis, genetic information, X-ray, CT scan, MRI, etc.).

In certain embodiments, the documents are financial documents.

In certain embodiments, the documents are confidential, proprietary, and/or not publically available.

It is contemplated that any embodiments described herein, including embodiments only described under one aspect of the invention, can be combined with any other embodiments of the invention, including those described under different aspects of the invention.

### BRIEF DESCRIPTION OF THE DRAWINGS

FIG. 1 shows components of an exemplary embodiment of the invention, with the arrows representing the flow of data.

### DETAILED DESCRIPTION OF THE INVENTION

### 1. Overview

The invention described herein overcomes one or more drawbacks relating to the compromising designs currently in practice, by, for example, combining various existing security mechanisms with new mechanisms in such a way that security and assurance are given priority over convenience, while retaining a user-experience that includes flexibility and ease of use.

One salient feature of the instant invention is that the data storage system separates the authorization process for management of access to the data storage device from the processes required to access and manipulate the electronic documents stored therein. In certain embodiments, authorization tasks are accomplished through a web console user interface provided by a web console server, while access to the sensitive electronic documents in the data storage system is provided by a separate document server. This decoupling of authorization from access provides more flexibility in choosing appropriate technologies for each task, while at the same time modeling what often happens in the real world, where authorization and access activities are often engaged at different times, and often by different people.

Besides reducing the likelihood of human error, this decoupling of authorization for access to the sensitive data from the access to the data itself also allows these functions and the mechanisms that support them to reside on different devices, with levels of security and protection specific and appropriate to the functions they perform and the sensitivity of the data which needs to be exposed to support those functions. Specifically, if the authorization is the key to the vault that stores the sensitive data, the key is obviously very important, but the contents of the vault are actually more important, and thus should have stronger protection.

Thus, in certain embodiments, the data storage system of the invention comprises three components, including a web console server, a data storage device, and a document server.

The web console server may be accessed by a user (e.g., a user who has legal, professional, or other obligations relating to the integrity, security and privacy of the electronically stored data, or an “administrative user”) through a web console user interface (e.g., a web browser on the user's local computer, smart phone, tablet), and may communicate with the data storage device (e.g., sending instructions relating to the status of the data on the data storage device). Meanwhile, a document viewer device may be used to establish a secure connection with the document server, which in turn communicates with the data storage device and allow a document viewer to access and otherwise manipulate documents in the data storage device (e.g. for viewing or editing). The document viewer may be the same administrative user or an associate user (such as one given access to the data by the administrative user). The document storage device may comprise an unarchived document module (e.g., intended or designed for the storage of documents of current relevance with a high potential for required access) and an archived document module (e.g., intended or designed for long term storage of documents with a low potential for required access) that stores unarchived and archived documents, respectively. Folders (e.g., top-level folders) containing documents may be moved between the two modules.

In certain preferred embodiments, only the top-level folders can be moved between the two modules, while sub-folders within the top-level folders are invisible from the web console user interface, and cannot be moved directly between the two modules.

Therefore, there are two interfaces by which a user interacts with the data storage system of the invention. Each of these interfaces needs to provide both a secure means of communication with the user and a high level of confidence in authentication, e.g., confidence in whom the system is interacting with.

Traditionally, when interacting with a web console, a typical data storage system employs standard Secure Sockets Layer (SSL) encryption to establish a secure connection with a user operating the web console. All traffic between the user controlled web console and the data storage system is encrypted using this technology. While widely accepted by most users as secure, SSL technology only provides one part of a secure solution, and has some inherent shortcomings that make it unsuitable on its own for sharing highly sensitive documents.

Although there are means to make it more secure, these means usually require users to go beyond SSL. The difficulties associated with doing so involve additional complexity, which is more likely to cause most users either to bypass these solutions altogether and to resort to other less secure methods, or to abandon file sharing altogether.

Additionally, users are usually not accustomed to sharing electronic documents through a web browser. Furthermore, newer devices, such as tablets and mobile phones, often do not provide web based interfaces suitable for accessing and viewing electronic documents (whether with or without the SSL network protocol).

Rather than impose on a user new methods for accessing electronic documents, the invention described herein allows the user to access and share electronic documents, especially private and/or sensitive electronic documents, using mechanisms that the user is already familiar with, such as drives and folders. By providing the user with a means to access electronic documents in standard folders within the device currently being used, the user is able to work in a familiar environment the user is comfortable with, thus minimizing the temptation to find work-around solutions that are the most common cause of privacy and security breaches. By providing this intuitive interface in a novel and secure way, the data storage system of the invention provides both security and increased likelihood that the user will access and share documents.

In certain embodiments, to verify the identity of the user on the web console user interface, the data storage system requires a physical token as a separate security credential, in addition to the standard user ID and user generated password. User identity is only verified, and access to the system is only granted, when both security credentials are verified. In certain other embodiments, additional security credentials may be required if additional access control or security is desired.

In certain embodiments, the physical token may be a device that provides a unique string of characters called a “one time password” (OTP) that the system can verify as originating from a particular physical device. Preferably, each successive use of the device generates a different unique string that may only be used once, which unique string may never be reused. The system may also be programmed to expect and only accept a different set of credentials every single time the user authenticates. Because authentication is linked to this physical device, the system can be sure that the device assigned to a particular user is present. Because the password provided corresponds to that same user, the system can be sure that the person using the system has knowledge of both the user ID and password and is in possession of the physical token. If a user attempts but fails to login through a predetermined number of times (e.g., three times in succession), the system may disable the account, deny further login attempts, and/or notifies the system administrators.

In certain embodiments, to accomplish a high level of assurance between the document viewer and the document server, the system leverages the high level of assurance provided by the web console server, by providing the strongly authenticated user with a string of characters, such as a security code (e.g., any combination of number, alphabetical letter, and non-alphabetical character, with any length, such as a 4-digit security code), that they can use to authenticate and gain access to the electronic documents. The user provides this security code along with their user ID and password to the document viewer device, which then uses that information to attempt to establish a secure connection to the document server. This allows the user to access their sensitive documents using standard software tools available on a variety of devices, providing strong authentication credentials, even when those tools (such as regular PC, smart phones, or tablets) were not designed with strong authentication in mind.

In other words, two or more pre-determined security credentials (such as a physical token that issues the OTP, and a password associated with that physical token) are required to access the web console server through the web console user interface. Using these pre-determined security credentials at the web console server results in the issuance of a time limited further security code, and it is this security code that is further required for accessing the separate document storage module—the unarchived document module, through using a separate document viewer device.

In certain embodiments, the system may comprise several layers of firewalls, which may be deployed with various system components in separate data centers. The system is designed such that multiple instances of each type of server component can be deployed to allow the entire system to scale for additional users and increased capacities.

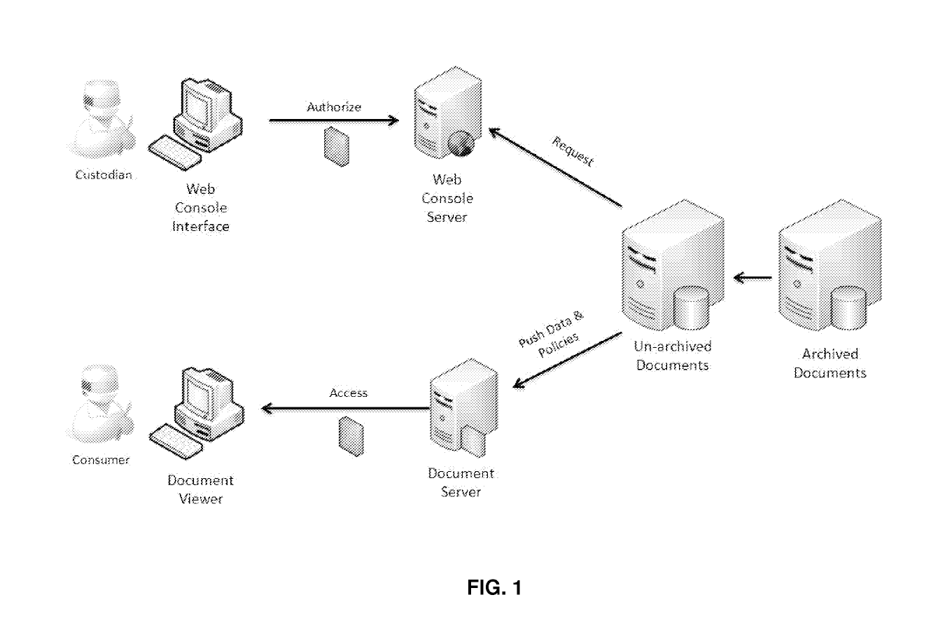

Having thus described the invention in general terms, reference will now be made to FIG. 1, which shows the components of an illustrative embodiment of the invention, with the arrows representing the flow of data.

The production system as shown is composed of several layers of firewalls, and is housed is in two highly secure data centers. The system is designed so that multiple instances of each type of server can be deployed to allow the entire system to scale. In the fully configured system, there are three main types of servers, including the web servers, the document servers, and the vault servers that embodies the data storage device. For the sake of simplicity, the configuration shown here does not address scalability and assumes that there is only one of each type of server. In reality, multiple servers of one or each type may be present in the system.

In the shown typical embodiment, the web console server and the document server interact directly with user connected systems, while the vault servers retrieves tasks/user instructions from the web console server, and directly interacts only with the document servers.

With the inventions generally described above, the sections below further define certain terms of the invention, and provides additional details about parts or components of the invention. The contents of the different sections should be read as a whole, and the various combinations and permutations of the system parts are contemplated to be within the scope of the invention.

### 2. Definitions

As used herein, “authentication” refers to a process by which a system accepts proof of identity. It is a common problem in information sharing to verify that a user is in fact who he/she says he/she is. Having a high level of confidence about who is accessing and using the system is critical for sharing personal and/or sensitive electronic documents.

As used herein, “data storage device” refers to any device, physical means, or media capable of storing information or data, or processing/managing/manipulating information or data, or both. The information stored therein may be in either an analog or digital format on a variety of media, including semiconductor, magnetic, or optical storage devices, and is either permanent or temporary (e.g., erasable). Exemplary data storage devices may include (without limitation), servers, hard drives, tape drives, RAMs, memory cards, flash memory devices, various optical storage (e.g., microform, hologram, optical disk, magneto-optical drive, holographic data storage, 3D optical data storage), etc.

“Unarchived document module” is a part of the data storage device that is designed to hold information or data that can be readily accessed by a user through a document viewer device.

“Archived document module” is a part of the data storage device that is designed to hold information or data that cannot be directly accessed. Folders in the archived document module can be moved to unarchived document module and become accessible, while folders in the unarchived document module can be moved to archived document module and becomes accessible only after they are returned to the unarchived document module.

“Web console user interface” includes any interface that allows a user to communicate with the web console server (as defined herein below). It may include any internet web browser configured to run on a user provided device, such as a personal computer, a tablet (e.g., iPAD), a mobile device with mobile web access (e.g., a smart phone, a BLACKBERRY type of device), or a terminal on a large computer network. It may also include input/output devices, such as a USB port, that receives information provided by the user. A user may use the web console user interface to provide the pre-determined security credentials (as defined herein), such as by typing in user name and password, or by supplying security credential through a physical device, or both.

“Web console server” is a server of the system that receives instructions and/or information from a web console user interface. It typically communicates remotely with the user device hosting the web console user interface, such as through the internet or intranet. A primary function of the web console server is to receive the required security credential(s) from the user, and authenticate the user. Once the user is authenticated, the user is granted access to the web console server such that the user may provide a number of instructions for processing by the data storage device, and may receive the security code required by a document viewer device to access documents in the unarchived document module. The instructions may include any functionality permitted by the system, including (without limitation): (i) creating a top-level folder in the unarchived document module (that stores documents in the unarchived document module); (ii) moving a top-level folder between the unarchived document module and the archived document module; (iii) inviting another to become an associate user; (iv) granting access to a top-level shared folder to the associate user; (v) revoking access to a top-level folder previously shared with an associate user; and/or, (vi) preventing the administrative user's account from being used to gain access to the document server (locking down), or reversing locking down.

“Security code” is a code generated by the system (e.g., data storage device) that may be required to access documents stored in the unarchived document module via the document viewer device. The security code can be a combination of any number, alphabetical, or non-alphabetical characters, and can be any length. It typically expires at a pre-determined time or after a pre-determined period of time (e.g., every hour, every day, every week, every month, etc.), or expires once per login, or expires after each locking down. In addition, the security code can also be manually refreshed through the web console interface.

“Lock down” refers to a process in which a user (e.g., an administrative user) revokes his/her own access to the system. This may be beneficial if the user has lost control of, or has lost his/her personal device used as the document viewer device. Locking down from any web console user interface (such as a public computer having internet access) allows the user to prevent an unauthorized 3rd party to gain access to the documents through the lost document viewer device. Preferably, when a user locks down, associates whom the user has shared with are still able to access the files using the associates' own credentials/account so that their authorized access to the documents is not interrupted.

“Document server” is a server of the system that is capable of establishing a secure connection with the document viewer device after receiving the security code provided by the web console server to the user and then supplied to the document viewer through the document viewer device. A document server typically authenticates a user through user name, password, and the security code obtained from the web console server. In embodiments where the document server requires the security code to establish secure connection with the document viewer device, an added layer of security is obtained in that the user must have previously obtained the security code from the web console server, a process which requires its own authentication security credentials. In addition, the fact that the security code expires at pre-determined intervals, or expires via manual intervention, provides added control over who can access the documents in the unarchived document module, and when.

“Manipulate (documents),” as used herein, includes the various actions a user can take with respect to the documents in the unarchived document module, which the user has successfully gained access to. It may include managing the documents (and/or subfolders) by adding, deleting, moving, renaming, or copying. It may also include viewing and/or editing the contents of the documents or subfolders. Different users may be granted different levels or privileges of manipulation, such that certain users can only perform a limited set of actions (e.g., view only, view and edit only without the ability to copy or move documents between folders or subfolders, etc.), while other users may perform all or substantially all actions, all commensurate with the respective privilege level granted.

### 3. Servers

In the fully configured system, there are three main types of servers, including web console servers, document servers, and data storage servers. For the sake of simplicity, scalability is not presumed, and only one of each type of server is used for illustrative purpose; however, the system is scalable through the use of multiple units of each type of server. The user interacts directly with two of the three types of servers in the subject system, the web console server (through the web console user interface), and the document server (through the document viewer).

The web console server communicates with the data storage device, and the document server makes the files stored on the data storage device available to the viewer. The data storage device comprises an unarchived document module for storing unarchived documents, and an archived document module for storing archived documents. The data storage device may be a single physical device with two logical partitions, or can be multiple physical devices, with one or more physical devices serving as the archived document module, and one or more other physical devices serving as the unarchived document module. The data storage device can move folders between the un-archived and archived document modules.

In certain embodiments, the protocols used to communicate among the components of the data storage system are specifically designed to increase security between components that communicate with each other, thus maximizing the security of the data storage system overall.

The system can be regarded as layered, where the outer layers (which, strictly speaking, is not part of the system) are exposed to the internet so that the user can access the inner layers of the system from anywhere with an internet connection. The more internal layers (e.g., the document server, the web console server, and the unarchived document module) are more constrained, and are less tolerant of errors or anomalies. The innermost layer is the archived document module for storing archived documents, which layer (and the archived documents therein) may be considered inaccessible unless such archived documents and the folders containing them are moved to the unarchived document module. Each layer may be constructed with its own defenses, constraints and detection systems, such that in order to compromise the system and gain access to the most sensitive data, an attacker must penetrate several increasingly difficult layers of the system without being detected.

Communication between the user's web browser and the web console server may take place using the SSL protocol, the de-facto standard for secure communications on the web. The SSL protocol as implemented in browsers relies on certificate authorities (CAs) to provide certificates that are used for encryption. While convenient for users and secure in theory, this reliance on third parties turns out to be a vulnerability in practice. Without assurance that the private keys of the CAs are in fact private, there is no way to ensure that so called secure connections are not being intercepted by third parties. These certificates are built-in to modern web browsers, and while these browsers do provide mechanisms for installing custom certificates, the process is cumbersome, implemented differently in every web browser, and often changes with each new browser version.

In addition, browsers are notoriously insecure, and thus in the context of highly sensitive documents, need to be treated as hostile environments. For these reasons, the invention improves data security by not transmitting sensitive documents through the SSL web interface, but rather relying on the web console user interface solely for administrative tasks.

The administrative functions provided by the user through the web console user interface (and the web console server), such as creating top-level folders, moving/removing top-level folders, sharing top-level folders, etc., are preferably communicated to the data storage device in a secure manner. Although no sensitive information is transmitted between these two components, the data storage device is still responsible for setting up and managing shared connections, and for providing a temporary access code to the user for access to the sensitive materials. A number of strategies may be employed at this point to minimize the chances of an attacker successfully gaining access to this interface and thus directly manipulating the administrative functions of the data storage device.

For example, in one embodiment, the data storage device may be limited to communicating with a single other computer, e.g., that of the web console server. Preferably, the identity of the single other computer is verified by a process that does not rely on the IP address of the single other computer, such as verification through a certificate validation process. The IP address of the single other computer may help to identify the computer, but it may not uniquely identify the single other computer. An attacker, for example, could try to place itself between the document server and the web console, and provide that same IP address of the single other computer to the document server. For this reason, the design of the invention does not actually rely on the IP address of the single other computer, but rather just uses the IP address to find the computer it is designed to communicate with.

In another embodiment, the console login credentials, including the OTP, must be provided by the web console directly to the data storage device in order to start a communication session.

In addition to being behind a network firewall, the web console server may be equipped with both a network intrusion detection mechanism as well as file level intrusion detection system. Thus, in order to communicate with the data storage device at all, an attacker would first have to attack and gain control of the web console server, and then mount an attack from that server, all without being detected.

As a further line of defense, all communication between the data storage device and the web console server may be initiated by the data storage device. To accomplish this, the web console is configured to “listen” on a particular port for calls from the data storage device. For example, every few seconds or so, the data storage device makes such a call and essentially asks the web console server if there are any tasks that need to be completed. If there are none, the data storage device waits for a period of time until a task appears, or it gives up and tries again.

Communication between the web console and the data storage device starts with the web console attempting to establish a session with the data storage device. It does this as part of the user authentication process, providing the user supplied username, user generated password and physical token to the data storage device by posting authentication task request for the data storage device to pick up and process. The data storage device then retrieves the authentication request task, examines the credentials supplied as part of the task request, and if it finds that the credentials match the user, it provides the web console with a session ID to use when communicating with it.

From this point forward, before the data storage device will process any tasks, those tasks must be accompanied by the unique session identifier. When the data storage device is provided with a task to complete, it first checks to see if the task is formatted correctly, and then it checks to see if the task has a valid session identifier. Or, if the web console server is in the process of establishing a new session, it checks to see if the credentials are correct.

Under ordinary conditions, the web console server should never pass an incorrectly formatted task request to the data storage device. Since this should never happen, if the data storage device does detect an invalid task, it assumes that the web console server has been compromised and it will immediately shut down the data storage device completely, prompting system administrator intervention. To be successful an attacker would have to communicate with the data storage device perfectly on the first attempt.

This communication strategy provides the invention with some unique properties. Firstly, in order to compromise the data storage device via the web console communication mechanism, an attacker would have to first gain control of the actual web console server or impersonate the web console server entirely including obtaining the IP address of the server and the server certificate identifying the server, and then the attacker would have to wait on the correct port for the data storage server to initiate communication session. The attacker would then have to construct a perfectly formed task on the first attempt, all without being detected.

Even if the attacker were to gain control of the web console server, the communication between that server and the data storage device is such that there is no way for the attacker to initiate an attack on the data storage device directly. Since the data storage initiates the connection in this very specific way, by relying on the data storage device to initiate the call, and no ports are exposed on the data storage device, all attacks would have to go through this very limited and sensitive mechanism.

In certain embodiments, the connection between these two servers is also encrypted with SSL to prevent eavesdropping. Preferably, these two servers are housed in completely geographically separate data centers.

In certain embodiments, the connection between these two servers employs a session ID established during the authentication process. In order for the request to the data storage device to be accepted it must contain this session ID as one of the request parameters. The initial session ID is provided to the web console server as part of the response to a successful authentication request, where the web console server has provided valid credentials in the form of a valid username accompanied with the correct user generated password and a valid OTP for that user. The initial session ID is then provided to the data storage device as part of the first request by the web console server. Upon the successful completion of that request, the data storage device returns a new session ID for the session and expires the previously used session ID. In this way, security is enhanced by ensuring session IDs are used at most once, and thus cannot be re-used by an eavesdropping attacker to gain unauthorized control of the data storage device.

Use of SFTP between document viewer device and document server provides a secure standardized connection mechanism that has wide support across device formats (computers, tablets, mobile phones). This connection mechanism does not rely on third party certificate authorities, so it is not susceptible to the type of “man-in-the-middle” attacks in the same way browsers are. SFTP employs a Trust-On-First-Use strategy, so the very first time a user connects a device to the document server, their device will be provided with the server fingerprint with which they can assure themselves that they are connected to the right document server and no one has placed themselves in the middle. If at a later date someone does place itself in the middle of the communication by impersonating the data storage device, the viewer device is able to detect that it is communicating with the wrong server even though the IP address is correct.

In certain embodiments, using the (4 digit) security code provided by the web console, the user can gain access to the document server for a predetermined period of time. Once that time expires, the user is required to re-authenticate to establish their identity. It is over this connection that the sensitive documents are made accessible to the user.

In certain embodiments, SFTP client software is implemented in such a way that it provides a service very much like native file systems found on all computer operating systems. SFTP client software so implemented is made to appear and behave exactly like a file system on the users' computer operating system, and the users can work directly with the documents, leaving the documents in the document server so that the documents are never stored on the local device. In this way, if the user's document viewer device being used to access the document server is ever misplaced or stolen, the sensitive information itself is not at risk because the information/documents never actually resides on the user's document viewer device itself.

In certain embodiments, in the event that a document viewer device is misplaced or stolen, or even for an added level of security, users of the invention have the ability to “lock down” the document server. In one embodiment, locking down removes user accounts from the document server so the accounts are no longer available to the server. Any devices that happen to be connected to the document server at the time of lock down are immediately disconnected. The access code is then discarded and the user's account is removed. At this point there is no way to connect to the document server using that particular user's credentials.

If the user then wants to gain access to their sensitive documents again, they can initiate an “unlock” using the web console server through the web console user interface. When this happens, a new user account is created in the document server, a new temporary access code is generated for that user, and the user can then connect to the document server again using its user ID, user generated password, and the newly created temporary access code. Once locked down, an account stays locked down until a user unlocks it.

In addition to being able to lock down accounts manually, in certain embodiment, the invention may automatically lock down all user accounts at predetermined time. This may be done with any pre-determined time period, e.g., daily, hourly, or weekly, etc., depending on desired configuration. Like the user initiated lock downs, when an account is locked down automatically, it stays locked down until the user unlocks the account through the web console server and web console user interface.

In addition to accessing their own documents, users have the ability to share documents with each other. Users may share folders through using the web console interface. Sharing may be done on a folder by folder basis. First, a user wishing to share a specific folder establishes an “Associate” relationship with another user on the system. Next, the user selects the specific folder he/she wishes to share and indicates which associate(s) he/she wishes to share that folder with. Preferably, only the user who created a folder can share the folder with other users. In one embodiment, folders can be shared with one associate, or with any number of associates. In one embodiment, each associate may be given a specific privileged so that the ability to manage documents in the shared folder is limited. For example, an associate user may either have read/write access to a folder, or have read-only access. Access privilege can also be revoked or changed at any time.

In the event of an account lockdown, either automatic or manual, only the account in question and all devices using the account in question are locked out of the data. Any associate users that have access to the data can continue to access it, through their own document viewer devices. To remove access from an associate (user), an administrative user can go to the folder shared with the associate user and remove that access privilege from the associate user.

Administrative users also have the ability to archive any folders, by moving the folders from the unarchived document module to the archived document module. When a folder is archived, it is no longer viewable in the document viewer device, nor is it available for sharing through the web console user interface.

### 4. Methods of Use

The data storage system of the invention can be used to store any data or information, especially data or information that is personal, confidential, privileged, and/or proprietary in nature, preferably data or information that is also designed to be shared among a limited/selected group of users. Thus the data storage system of the invention has a wide range of use in a diverse field, including medical, legal, and financial industries.

### Legal

The data storage system of the invention may be used to facilitate information/data exchange among client and attorneys to preserve confidentiality and/or attorney-client privilege.

For example, the client may deposit sensitive information in the archived document module, and has full control over when and which documents are moved over to the unarchived document module for sharing with the attorney. The attorney may be invited as an associate user to access a shared folder containing information deposited by the client and information desired to be shared with the attorney. If the client dismisses the current attorney and hires a different attorney, the client does not need to request the previous attorney to return any sensitive information or documents that were previously accessed by the previous attorney. This ensures that the client takes full control of its documents and sensitive information, and there is significantly reduced chance that such sensitive information possessed by the previous attorney may be accidentally leaked by a third party “attacking” the electronic files of the previous attorney.

By similar means, the client can simultaneously engage different legal teams from different firms, each given appropriate level of access to information pertinent to the legal tasks at hand.

The data storage system of the invention may also facilitate sharing of information among attorneys at the same firm, especially in cases where legal ethical wall is established among the attorneys of the firm, where a first group of attorneys working for a first client is required not to share first client information with a second group of attorneys working for a second client, and vice versa. In this case, a lead attorney in the first group of attorneys may store information relating the first client in a shared folder, and invite only attorneys in the first group to access such information. Conversely, a lead attorney in the second group may only share information relating the representation of the second client only among the second group of attorneys. This minimizes the chance that the ethical wall may be accidentally breached and the firm subject to legal malpractice liability.

### Medical

The data storage system of the invention may be used to facilitate information/data exchange among patients and the one or more physicians or healthcare workers serving the patients, in order to preserve patients' medical confidentiality, doctor-patient relationship, and/or physician—patient privilege.

For example, using the system of the invention, a patient may become an administrative user that controls all the documents relating to medical history, exam or test data of the patient. The patient can then share all or portion of the documents with his/her primary care physician, one or more specialist (with or without being referred to by the primary physician), commercial diagnostic test companies, health insurance companies, potential employers, or any one the patient chooses to share such documents, through inviting such persons as associate users of certain selected shared folders containing relevant information.

Alternatively, a patient's primary care physician may be the administrative user who controls who can access information determined to be appropriate for sharing by the primary care physician.

In either cases, the administrative user not only has a complete collection of all the relevant medical information of the patient, but also controls the content of the shared folders, with whom each shared folder is to be shared, and the duration of the sharing.

### Financial

The data storage system of the invention may be used to facilitate information/data exchange among an individual or his/her financial advisors about any and all information relating to the individual's financial matters, such that the financial advisors may provide their respective services with much reduced risk of accidental leak of sensitive financial information.

The exemplary uses above are merely a selected few out of essentially unlimited possibilities concerning data/document control and sharing. One of ordinary skill in the art can readily envision other uses of the systems of the invention without departing from the spirit of the invention.

### EXAMPLE OF AN ESTABLISHED SYSTEM

In a fully established system, users of the system use a standard web browser, such as the Microsoft Internet Explorer (IE), and an SFTP client software, such as ExpanDrive, on their personal computers.

From the users' perspective, users interact with the system in two ways. First, they use their web browsers to connect to the web console at a given web address (for example, secure.mddatabank.com), where they log in and make changes to their accounts and configure their folders. Second, they use their SFTP client software to connect to the document server at a given host address (for example: vault.mddatabank.com) where they are able to access their documents.

System configuration and designed operations for an actually established data storage system of the invention are described below for illustrative purpose only. Other variations of the system can be readily made without departing from the spirit of the invention. Any and all specific devices and configurations described herein below are contemplated to be generally applicable to the invention, although none is intended to be limiting.

Specifically, the web console server is a computer running the Linux operating system using the Apache Web Server. The Apache server is equipped with a certificate corresponding to the name secure.mddatabank.com.

When users use their web browsers to connect to the web console server running Apache, the web console server establishes an encrypted connection with the browsers by redirecting any HTTP requests to the secure HTTPS server on port 443. Once that connection is established, users can, if they so wish, verify that the certificate being provided by the server is in fact a certificate corresponding to the server they intended to connect to. In the case of this example, that server would be secure.mddatabank.com.

As soon as the server accepts the initial HTTPS request, it establishes a session, by way of a randomly generated session ID passed back to the server as a cookie embedded in the requested page.

At this point, the server does not know the identity of the user, only that there is a user, and that the user is assigned a particular session ID and is connected over an encrypted connection. The session ID has a timeout associated with it, both at the cookie expiry level and at the server level. Thus if the user stops using the web site for a certain (pre-determined) length of time, the session expires. If the user then starts to use the site again, a new session is established. The cookie is secure so that it will only work if there is a secure connection.

Unidentified users are allowed to browse the external pages of the web site. If the unidentified users then decide they want to access their web console, the server needs first to establish the users' identity. The system requires two-factor authentication, and, as such, is equipped with the ability to accept tokens generated by a physical device issued to the account holder when they established their account with the service provider.

In this example, the system accepts tokens generated by a physical device called a Yubikey (manufactured by Yubico). The Yubikey has the ability to provide a token in the form of a one-time password (OTP) that can be verified by a service that Yubico provides that runs on their servers elsewhere on the internet. Each Yubikey has an embedded ID which is included in the OTP that is associated with the user on the invention servers. Other similar or compatible devices may also be used for the same purpose.

When users are ready to login to the web console, they click on the login link and are presented with three data fields to fill in. In the first field, users enter their username. In the second field, they enter a password that has previously been assigned to their accounts on the server. In the third field, users insert their Yubikey into any available USB port on their personal computers and press the button on the Yubikey. The Yubikey then enters the OTP into the data field. Users then click the login button to complete the login process.

Data in these three fields is then received by the web console server. At this point, the web console makes a request to the data storage device in order to authenticate the user. If the data storage device is able to verify the username and password, and that the OTP supplied is in fact assigned to the username provided, it issues a request out to external servers elsewhere on the internet to verify that the OTP provided is valid. If the OTP turns out to be valid, it returns an internal session identifier to the web console server, which then generates the page for the user's web console. If the data storage device finds that the credentials provided are invalid, it returns an error code to the web console device, which then returns a message to the user indicating the credentials were invalid.

In this example, the web console device also counts the number of failed attempts. If the failed attempts exceed 3 (or any pre-determined number), and if the username provided is a valid username, the account corresponding to that username is disabled.

In the invention, the web console server is considered less secure than the data storage device, thus, the data storage device is responsible for authenticating the user, and the web console server relies on that authentication.

As previously described, the web console server is unable to connect to the data storage device because the data storage device does not expose any ports for connections. Instead, the data storage device connects to the web console server. To achieve this in the example, the Apache server on the web console server provides a web service on a second port, such as port 8080. This port is configured to only communicate using an encrypted HTTPS connection, and it uses the secure.mddatabank.com certificate for that connection. In addition, it is configured to only accept connections from the IP address of the data storage device and to require certificate authentication from the data storage device.

This second connection on the Apache server runs a CGI script that has the ability to check a queue for requests for tasks to perform. When the web console server needs the data storage device to perform a task, such as authenticating a user, it places a message file representing a request into a queue. The message file is of a specific format, and contains any parameters that are required to perform the task being requested. In the case of an authentication request, it contains the name of the request, the username, the password, and the OTP provided.

The CGI script is called periodically by the data storage device, in this example, every 0.5 seconds, to see if there are any messages in the queue. If there is a message the CGI returns that message to the data storage device. The data storage device attempts to satisfy the request, and it then calls the CGI script again to post the results of the request for the web console server to use.

Each time the data storage device calls the CGI program on the web console server, it checks the certificate provided by the web console server to make sure it is talking to/communicating with the correct computer, and not a computer pretending to be the server.

Every request retrieved from the web console server also contains an internal session identifier, which it uses to ensure that the request is coming from an authenticated user. This internal session identifier has an expiry time associated with it, and it is changed with every successive call so that it can only be used once.

The only task that the data storage device executes without this internal session identifier present is the authentication task where the user initially establishes their identity as previously described.

The data storage device expects very specific requests in very specific formats, with unique and changing identifiers. In our example, if any of these are found to be invalid, it stops processing requests and notifies the administrator via SMS message and email.

Once the user has established their identity and successfully logged in, they are able to make changes to their folders, creating, deleting and renaming them, as well as sharing them with associates. All of these tasks are accomplished by placing requests into the queue and waiting for them to be executed and then using the response provided.

The data storage device consists of an archived documents module, an unarchived documents module and a document server. In this example, the document server is an SFTP server that can be controlled via a SOAP API, the unarchived documents module is disk storage that can be accessed by the SFTP server and the archived document module is disk storage that cannot be accessed by the SFTP server.

Once authenticated the user is able to perform several functions which affect the data storage device. All of these functions result in the web console server placing a request in the queue, as described above, which is then picked up and processed by the data storage device via the second connection to the web console server. Some of these functions are: lockdown, unlock, create folder, delete folder, archive folder, unarchive folder.

Normally, when a user authenticates, the data storage device checks to see if the user account is locked. If it is not locked, the user is able to connect to the document server with their SFTP client software (such as ExpanDrive). When the user authenticates and their account is not locked, the data storage devices checks with the SFTP server to make sure that there is a valid account for the user to connect with. If the user account is locked at the time of authentication, the data storage devices checks the SFTP server to make sure there is not a user account for that user, and if there is, it deletes it. The user is able to lock/unlock their user account from the web console whenever they want to, and additionally, in our example, the data storage device is configured to delete all SFTP user accounts at midnight local time. This deleting of user accounts during lockdown and periodically greatly reduces the chances of sensitive data being accessed when a device is compromised, such as when a user accidentally leaves their computer in a restaurant.

In addition to being configured with active user accounts, the SFTP server is also configured to provide access top level folders to the connecting SFTP clients. Multiple top level folders are provided rather than just one top level folder, so that users can share top level folders with different associates with each top level folder having it's own unique set of permissions granted to those users. So, in our example, Individual A may want to share one set of folders with her associate Individual B in a read-only fashion, so that Individual B can only read the documents but not modify them. Individual A may then want to create a second folder as a shared work space where both individuals as well as a third individual C can all read, create and modify documents. These two top level folders are then physically created as folders in the unarchived document module and the SFTP server is then configured to provide access to those folders to any connecting SFTP clients. The configuration of a top level folder mapped to a folder in the physical storage device in the unarchived document module is called a pointer. Each pointer has permissions associated with it. In our example, two physical folders would be created in the data storage device in Individual A's area, and five pointers would be added. Two for Individual A, two for Individual B, and one for Individual C.

When a top level folder is deleted from the system, the SFTP server is first instructed to remove any associated pointers and then the physical folder is removed from the unarchived document module in the data storage device.

When a top level folder is archived on the system, the SFTP server is first instructed to remove any associated pointers, and then the physical folder is moved from the unarchived document module to the archived document module, which is inaccessible to the SFTP server.

When users want to connect to the SFTP server using their SFTP client software, they provide the software with the host name for the server (in our example, vault. mddatabank.com), along with their usernames and a passwords. In our example, the password in this case is the concatenation of their user defined password followed by a four digit code generated by the data storage device with every unlock operation, and provided to the user via the web console interface. This four digit code is time limited because it is discarded every time the user account is locked down, which can be initiated by the account holder, and in the case of our example, set to occur every night at midnight.

1. A data storage system, comprising:
(a) a data storage device, comprising an unarchived document module that stores unarchived documents and an archived document module that stores archived documents;
(b) a web console server, wherein the web console server receives instruction and/or information from an administrative user through a web console user interface, wherein the web console server grant the administrative user access to the web console server after receiving two or more pre-determined security credentials, and wherein the administrative user, having gained access to said web console server, is capable of:
(i) obtaining a security code required by a document viewer device to access documents in the unarchived document module;
(ii) creating a top-level folder in the unarchived document module (that stores documents in the unarchived document module);
(iii) moving a top-level folder between the unarchived document module and the archived document module;
(iv) inviting another to become an associate user;
(v) granting access to a top-level shared folder to the associate user;
(vi) revoking access to a top-level folder previously shared with an associate user; and/or,
(vii) preventing the administrative user's account from being used to gain access to the document server (locking down), or reversing locking down;
(c) a document server, wherein the document server establishes a secure connection with the document viewer device after receiving the security code provided by a document viewer through the document viewer device, and grants the document viewer access to documents stored in the unarchived document module, wherein the document viewer, having gained access to the unarchived document module, is capable of:
(i) creating a sub-folder within the top-level folder in the unarchived document module, or within another sub-folder; and
(ii) manipulating [managing (adding, moving, copying, or deleting), viewing, and/or editing] documents stored in the unarchived document module commensurate with a policy/privileged associated with the document viewer.

2. The data storage system of claim 1, wherein one of said two or more security credentials is a user-determined password.

3. The data storage system of claim 1, wherein one of said two or more security credentials is a token generated by a physical device (such as a YubiKey).

4. The data storage system of claim 1, wherein the security code expires at a pre-determined time or after a pre-determined period of time (e.g., every hour, every day, every week, every month, etc.), or expires once per login, or expires after each locking down.

5. The data storage system of claim 1, wherein the security code is refreshed through the web console interface.

6. The data storage system of claim 1, wherein the top-level folder contains identification information (such as folder name, number of documents within the folder).

7. The data storage system of claim 1, wherein the top-level folder can be designated to be a top-level shared folder (for access by the associate user).

8. The data storage system of claim 1, wherein the document viewer device is the same device that hosts the web console user interface.

9. The data storage system of claim 1, wherein the unarchived document module and the archived document module are within the same physical device.

10. The data storage system of claim 1, wherein the document server and the unarchived document module are within the same physical device.

11. The data storage system of claim 1, wherein the document viewer device is different from the device that hosts the web console user interface.

12. The data storage system of claim 1, wherein the unarchived document module and the archived document module are physically distinct devices that may optionally be located in different geographic locations.

13. The data storage system of claim 1, wherein the document server and the unarchived document module are physically distinct devices.

14. The data storage system of claim 1, wherein the document viewer device is a personal computer (PC or Macintosh), a tablet device (iPad, PC tablets), or a smart phone (iPhone, android device, blackberry etc.).

15. The data storage system of claim 1, wherein the secure connection between the document viewer device and the document server is based on SFTP.

16. The data storage system of claim 1, wherein the content of the archived or unarchived documents is not accessible through the web console user interface or the web console server.

17. The data storage system of claim 1, wherein content of the archived document module is not visible and not accessible through the document viewer device.

18. The data storage system of claim 1, wherein the document viewer is the administrative user, or the associate user.

19. The data storage system of claim 1, wherein the associate user has limited privilege to manage content of the data storage device.

20. The data storage system of claim 1, wherein communication between the data storage device and the web console server is established by the web console server providing (one-way) instructions that are capable of being processed by the data storage device when the data storage device is ready to process instructions.

21. The data storage system of claim 1, comprising multiple web console servers, each in communication with one administrative user.

22. The data storage system of claim 1, wherein the document server establishes secure connection with multiple document viewer devices, optionally simultaneously.

23. The data storage system of claim 1, wherein documents stored in the data storage device are medical records of a patient, wherein the administrative user is a physician of the patient, and the associate user is another physician of the patient.

24. The data storage system of claim 1, wherein documents stored in the data storage device are proprietary or confidential, and wherein the administrative user is a custodian of the documents.

25. A method of storing documents, comprising saving said documents in a data storage system of any of the above claims.

26. The method of claim 25, wherein a first portion of said documents are stored in the unarchived document module, and a second portion of said documents are stored in the archived document module.

27. The method of claim 26, further comprising using the web console user interface to gain access to said web console server.

28. The method of claim 27, further comprising performing one or more of (i)-(vii).

29. The method of claim 28, further comprising using a document viewer device to access the unarchived document module.

30. The method of claim 29, further comprising performing (1) or (2).

31. The method of claim 25, wherein the documents are confidential legal documents/instruments (e.g., certificate, deed, bond, contract, agreement, will, invention disclosure etc.).

32. The method of claim 25, wherein the documents are medical documents (patient lab test data, health history, family health history, treatment history, diagnosis, prognosis, genetic information, X-ray, CT scan, MRI, etc.).

33. The method of claim 25, wherein the documents are financial documents.

34. The method of claim 25, wherein the documents are confidential, proprietary, and/or not publically available.
